(19) United States
(12) Patent Application Publication
(10) Pub. No.: US 2018/0239731 A1
(43) Pub. Date: Aug. 23, 2018

(54) SYSTEM AND METHOD FOR MONITORING EXTERNAL UNITS ASSOCIATED WITH DATA STORAGE SYSTEMS

(71) Applicant: International Business Machines Corporation, Armonk, NY (US)

(72) Inventors: Janice H. Brown, Garland, TX (US); Shawn O. Brume, Tucson, AZ (US); Carlos Sandoval Castro, Zapopan (MX); Alicia Martinez Cruz, Guadalajara (MX); Lawrence M. Fuss, Tucson, AZ (US); Julio Cesar Hernandez Bañales, Zapopan (MX)

(21) Appl. No.: 15/439,298

(22) Filed: Feb. 22, 2017

(51) Int. Cl. G06F 13/38; G06F 3/06; G06F 11/30

(52) U.S. Cl. CPC G06F 13/387; G06F 3/0659; G06F 3/061; G06F 11/3034; G06F 11/3051; G06F 11/3089; G06F 3/068

(57) ABSTRACT

A sensing device for monitoring operational conditions of an external unit associated with a data storage system includes a processor, an electromagnetic sensing coil associable to, such as, in proximity to and/or couplable to a power line to the external unit and a communication interface configured to communicative with the data storage system. The processor of the sensing device may be configured to receive a signal from the electromagnetic sensing coil that is indicative of operational conditions of the external unit, convert the received signal to a SCSI data command; and transmit the converted SCSI data command to a controller of the data storage system. The SCSI command may comply with the Automation/Drive Interface (ADI) standard.

### BACKGROUND

This disclosure relates to methods and systems for monitoring external units in a data storage system, and in particular to monitoring and reporting the operational condition of an external unit, e.g., an environmental conditioning unit such as, for example, an air conditioner, associated with a data storage system.

Efforts to improve the performance of traditional data storage centers attempt to minimize the cost of processing and storing data. One option that is employed to reduce operational costs of data centers is to run the equipment in the data center at the high end of its environmental operational limits, thereby reducing cooling requirements and operational costs of the data center. In other words, data centers are running increasingly hot and more humid conditions than traditional data centers in an attempt to reduce operating costs. In an effort to control the environment within data storage libraries so as to provide improved working conditions for data storage media, data storage drives, etc., e.g., magnetic tape media and drives, environmental conditioning units (e.g., air-conditioning units) may be associated with and/or incorporated into the data storage libraries themselves to control the temperature, humidity and/or other environmental conditions within the interior of the data storage library.

Current systems for environmental control in existing data storage systems do not enable monitoring of many types of external units associated with the data storage systems such as, for example, the associated environmental conditioning units including, for example, air conditioning units.

### SUMMARY

In an embodiment, a sensing device for monitoring operational conditions of an external unit associated with a data storage system includes a processor, an electromagnetic (EM) sensing coil that is couplable to a power line to the external unit, a communication interface communicatively couplable to a communication interface of the data storage system, and a computer-readable medium containing programming instructions that are configured to cause the processor to perform a number of functions. In one embodiment, the processor is configured to receive, via the EM sensing coil, a signal indicative of operational conditions of the external unit; convert the received signal to a SCSI data command; and transmit, via the communication interface, the converted SCSI data command to a controller of the data storage system.

In one embodiment, the external unit may be an environmental conditioning unit such as, for example, an air conditioning unit, and the EM sensing coil may be inductively couplable to a power line of the air conditioning unit. The sensing device may receive a signal from the EM sensing coil that is indicative of operating current drawn by the air conditioning unit. The communication interface may be an Ethernet interface. The sensing device may optionally include an analog-to-digital (AID) converter to convert a received analog signal from the EM sensing coil to a digital signal, and the processor of the sensing device may convert the digital signal to the SCSI data command.

In one embodiment, a process for monitoring operational conditions of an external unit associated with a data storage system may include receiving, by a processor of a sensing device via an EM sensing coil of the sensing device, a signal indicative of operational conditions of the external unit of the data storage system, where the EM sensing coil is inductively couplable to the external unit. The process also includes converting the received signal to a SCSI data command, and transmitting, by the sensing device, the converted SCSI data command to a controller of the data storage system via a communication interface. The communication interface is communicatively couplable to a communication interface of the data storage system. The sensing device may receive a signal from the EM sensing coil that is indicative of operating current drawn to the air conditioning unit. The communication interface may be an Ethernet interface. The sensing device may optionally include an analog-to-digital (A/D) converter to convert a received analog signal from the EM sensing coil to a digital signal, and the processor of the sensing device may convert the digital signal to the SCSI data command.

In above illustrated embodiments, the data storage system is using Automation/Drive Interface (ADI) standard in communicating with storage drives and other devices, and the SCSI data command may be a vendor-specific field complying with ADI standard.

### BRIEF DESCRIPTION OF THE DRAWINGS

FIG. 1A is a perspective view of an automated data storage library according to one embodiment.

FIG. 1B is a perspective view of another embodiment of an automated data storage library.

FIG. 2 is a perspective view of the interior of a storage frame from the data storage library of FIGS. 1A & 1B.

FIG. 3 is a block diagram of an automated data storage library according to one embodiment.

FIG. 4 is a block diagram depicting a controller configuration according to one embodiment.

FIG. 5 is a partial side view of a system for storing magnetic recording media, in accordance with one embodiment.

FIG. 6 is a diagram showing a sensing device in communication with a data storage system and an environmental conditioning unit according to one embodiment.

FIG. 7 is a diagram of a sensing device according to one embodiment.

FIG. 8 is an example a SCSI data command according to the ADC standard according to one embodiment.

FIG. 9 is a diagram of a process of monitoring the environmental condition of a data storage system according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

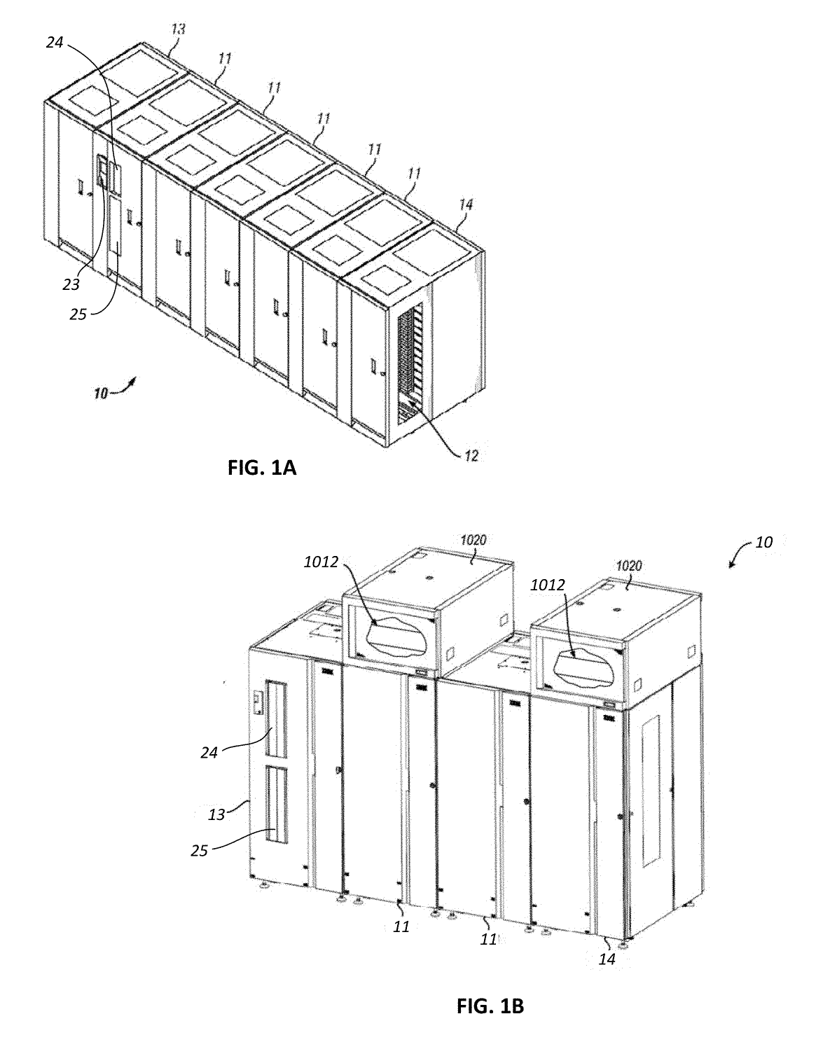

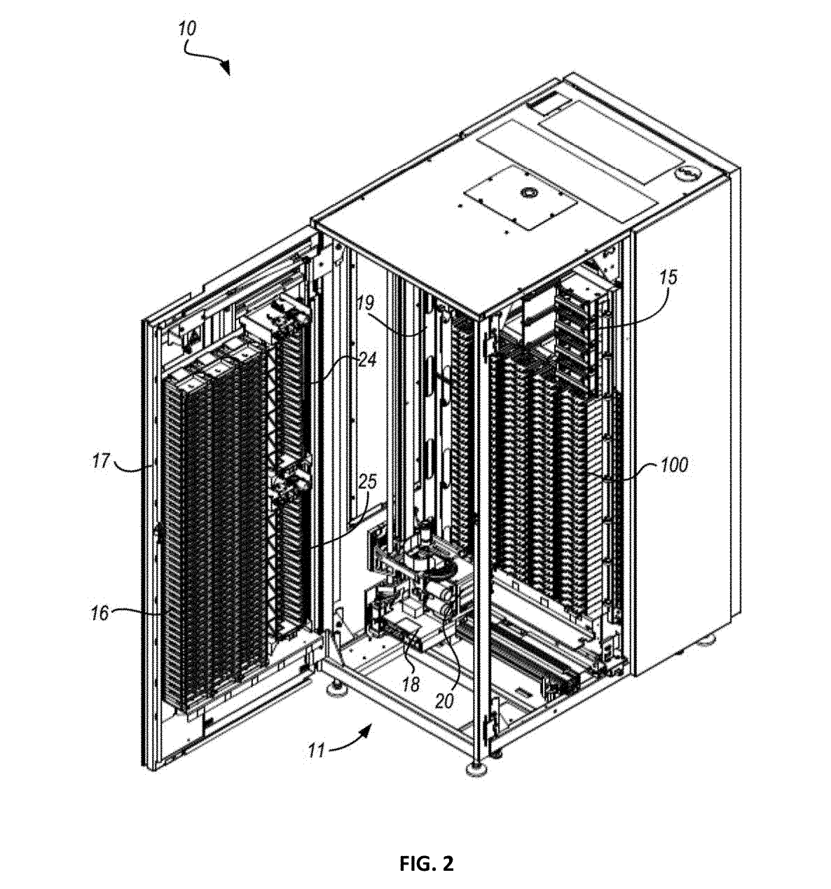

FIGS. 1A & 1B and FIG. 2 illustrate an example of a data storage system, e.g., an automated data storage library 10 which stores and retrieves data storage cartridges, containing data storage media (not shown), from multi-cartridge deep slot storage cells 100 and single cartridge storage slots 16. Examples of an automated data storage library which has a similar configuration as that depicted in FIG. 1A and FIG. 2, and may be implemented with some of the various approaches herein may include IBM TS4500 Library or the IBM 3584 UltraScalable Tape Library.

The library 10 in the embodiment of FIG. 1A comprises a left hand service bay 13, one or more storage frames 11, and right hand service bay 14. The library 10 of FIG. 1B comprises a left handed service bay 13, one or more storage frames 11, a right handed service bay 14 and optional environmental conditioning units 1012 which may control the temperature, humidity and/or other environmental conditions in the interior of the library 10. While two environmental conditioning units are shown in FIG. 1B, it will be appreciated that more or less environmental conditioning units 1012 may be associated with the library, and in circumstances the library may have no environmental conditioning units. As will be discussed in further detail below, a frame may comprise an expansion component of the library. Thus, storage frames may be added or removed to expand or reduce the size and/or functionality of the library. According to different approaches, frames may include additional storage slots, deep storage slot cells, drives, import/export stations, accessors, operator panels, controller cards, communication cards, etc. Moreover, an accessor channel 12 preferably extends between the storage frames and bays of the embodiments in FIGS. 1A & 1B thereby allowing an accessor to move between frames. A moveable and/or deployable panel 21 may be displaced to cover and/or block (as well uncover and/or unblock) channel 12 from communicating with the exterior of the data storage library. Panels 23-25 may be moved and/or removed to permit access to the interior of the service bays 13, 14. One or more panels may also be a window to permit visibility into the library 10.

FIG. 2 shows an exemplary embodiment of a storage frame 11, which may act as the base frame of the library 10. The storage frame 11 illustrated in FIG. 2 may have only a single accessor 18 (i.e., there are no redundant accessors) and no service bay. However, in other embodiments, a storage frame may include multiple robotic accessors and/or service bays.

Looking to FIG. 2, the library 10 is arranged for accessing data storage media in response to commands from at least one external host system (not shown). The library 10 includes a plurality of storage slots 16 on front wall 17 and a plurality of multi-cartridge deep slot cells 100 on rear wall 19, both of which may be used for storing data storage cartridges that may contain data storage media. According to one approach, the storage slots 16 are configured to store a single data storage cartridge, and the multi-cartridge deep slot cells 100 are configured to store a plurality of data storage cartridges. The arrangement and positioning of the storage slots 16 and the deep slot cells 100 may be different than illustrated in FIG. 2.

With continued reference to FIG. 2, the storage frame 11 of the library 10 also includes at least one data storage drive 15, e.g., for reading and/or writing data with respect to the data storage media in the data storage cartridges. Additionally, a first accessor 18 may be used to transport data storage cartridges containing data storage media between the plurality of storage slots 16, the multi-cartridge deep slot cells 100, and/or the data storage drive(s) 15. According to various approaches, the data storage drives 15 may be optical disk drives, magnetic tape drives, or other types of data storage drives that are used to read and/or write data with respect to the data storage media.

As illustrated, the storage frame 11 may optionally include an operator panel or other user interface, such as a web-based interface, which allows a user to interact with the library 10. Optionally, the library 10 may have an associated software application having a user interface, which also allows a user to interact with the library 10. The software application may be executable on a computing device, a remote server, a cloud or a mobile device.

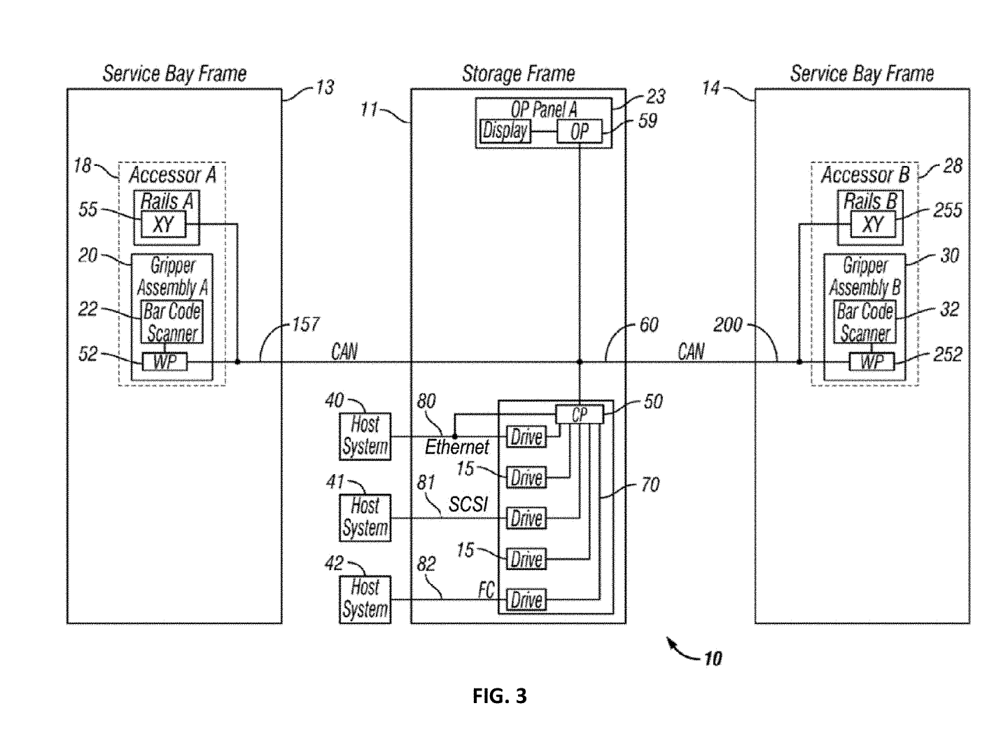

Referring now to FIG. 3, the automated data storage library 10 as described in reference to FIGS. 1A & 1B and FIG. 2, is depicted according to one embodiment. According to a preferred approach, the library 10 may employ a controller, e.g., arranged as a distributed system of modules with a plurality of processor nodes.

In one approach, the library is controlled, not by a central controller, but rather, by a distributed control system for receiving logical commands and converting the commands to physical movements of the accessor and gripper, and for operating the drives in accordance with the desired physical movements. The distributed control system may also provide logistical support, such as responding to host requests for element status, inventory, library status, etc. The specific commands, the conversion of those commands to physical movements of the accessor, gripper, controllers, and other components, and the operation of the drives may be of a type known to those of skill in the art.

While the automated data storage library 10 has been described as employing a distributed control system, various other approaches described and/or suggested herein may be implemented in automated data storage libraries regardless of control configuration, such as, but not limited to, an automated data storage library having one or more library controllers that are not distributed.

With continued reference to FIG. 3, library 10 receives commands from one or more host systems 40, 41, 42. The host systems 40, 41, 42, such as host servers, communicate with the library directly, e.g., on line 80 (e.g., path), through one or more control ports (not shown), or through one or more data storage drives 15 on paths 81, 82. Thus, in different approaches, the host systems 40, 41, 42 may provide commands to access particular data storage cartridges and move the cartridges, for example, between the storage slots 16, the deep slot cells 100, and the data storage drives 15. The commands are typically logical commands identifying the data storage cartridges or data storage cartridge media, and/or logical locations for accessing the media. Furthermore, it should be noted that the terms “commands” and “work requests” are used interchangeably herein to refer to such communications from the host system 40, 41, 42 to the library 10 as are intended to result in accessing particular data storage media within the library 10 depending on the desired approach.

According to one embodiment, the library 10 may be controlled by a library controller. Moreover, in various approaches, the library controller may include a distributed control system receiving the logical commands from hosts, determining the required actions, and/or converting the actions to physical movements of the first and/or second accessors 18, 28 and/or gripper assemblies 20, 30. In another approach, the distributed control system may have a plurality of processor nodes, each having one or more computer processors. According to one example of a distributed control system, a communication processor node 50 may be located in a storage frame 11. The communication processor node provides a communication link for receiving the host commands, either directly or through the drives 15, via at least one external interface, e.g., coupled to line 80.

As illustrated in FIG. 3, the communication processor node 50 is coupled to each of the data storage drives 15 of a storage frame 11, via lines 70, and may communicate with the drives 15 and with host systems 40, 41, 42. Alternatively, the host systems 40, 41, 42 may be directly coupled to the communication processor node 50, at line 80 (e.g., input) for example, or to control port devices (not shown) which connect the library to the host system(s) with a library interface similar to the drive/library interface. As is known to those of skill in the art, various communication arrangements may be employed for communication with the hosts and with the data storage drives. In the example of FIG. 3, lines 80 and 81 are intended to be Ethernet and a SCSI bus, respectively, and may serve as host connections. However, path 82 comprises an example of a Fibre Channel bus which is a high speed serial data interface, allowing transmission over greater distances than the SCSI bus systems.

According to some approaches, the data storage drives 15 may be in close proximity to the communication processor node 50, and may employ a short distance communication scheme, such as Ethernet, or a serial connection, such as RS-422. Thus, the data storage drives 15 may be individually coupled to the communication processor node 50 by lines 70. Alternatively, the data storage drives 15 may be coupled to the communication processor node 50 through one or more networks.

Furthermore, additional storage frames 11 may be provided, whereby each is preferably coupled to the adjacent storage frame. According to various approaches, any of the additional storage frames 11 may include communication processor nodes 50, storage slots 16, storage cells 100, data storage drives 15, networks 60, etc.

An automated data storage library 10 typically comprises one or more controllers to direct the operation of the automated data storage library. Moreover, host computers and data storage drives typically include similar controllers. A library controller may take many different forms and may comprise, for example, but is not limited to, an embedded system, a distributed control system, a personal computer, a workstation, etc. The term “library controller” as used herein is intended in its broadest sense as a device that includes at least one processor, and optionally further circuitry and/or logic, for controlling and/or providing at least some aspects of library operations.

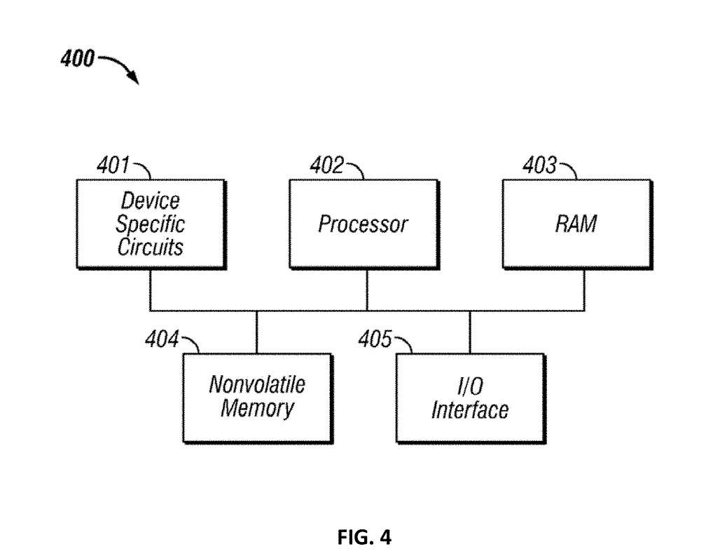

Referring now to FIG. 4, a typical controller 400 is shown with a processor 402, Random Access Memory (RAM) 403, nonvolatile memory 404, device specific circuits 401, and I/O interface 405. Alternatively, the RAM 403 and/or nonvolatile memory 404 may be contained in the processor 402 as could the device specific circuits 401 and I/O interface 405. The processor 402 may comprise, for example, an off-the-shelf microprocessor, custom processor, Field Programmable Gate Array (FPGA), Application Specific Integrated Circuit (ASIC), discrete logic, etc. The RAM 403 is typically used to hold variable data, stack data, executable instructions, etc.

According to various approaches, the nonvolatile memory 404 may comprise any type of nonvolatile memory such as, but not limited to, Electrically Erasable Programmable Read Only Memory (EEPROM), flash Programmable Read Only Memory (PROM), battery backup RAM, hard disk drives, etc. However, the nonvolatile memory 404 is typically used to hold the executable firmware and any nonvolatile data containing programming instructions that can be executed to cause the processor 402 to perform certain functions.

In some embodiments, the I/O interface 405 may include a communication interface that allows the processor 402 to communicate with devices external to the controller. Examples of the communication interface may comprise, but are not limited to, serial interfaces such as RS-232, USB (Universal Serial Bus), Small Computer Systems Interface (SCSI), RS-422 or a wireless communication interface such as Wi-Fi, Bluetooth, near-field communication (NFC) or other wireless interfaces. The controller 400 may communicate with an external device via the communication interface 405 in any communication protocols such as Automation/Drive Interface (ADI).

The device specific circuits 401 provide additional hardware to enable the controller 400 to perform unique functions including, but not limited to, motor control of an accessor cartridge gripper. Moreover, the device specific circuits 401 may include electronics that provide, by way of example but not limitation, Pulse Width Modulation (PWM) control, Analog to Digital Conversion (ADC), Digital to Analog Conversion (DAC), etc. In addition, all or part of the device specific circuits 401 may reside outside the controller 400.

While the automated data storage library 10 is described as employing a distributed control system, the various approaches described and/or suggested herein may be implemented in various automated data storage libraries regardless of control configuration, including, but not limited to, an automated data storage library having one or more library controllers that are not distributed. Moreover, a library controller may comprise one or more dedicated controllers of a library, depending on the desired embodiment. For example, there may be a primary controller and a backup controller. In addition, a library controller may comprise one or more processor nodes of a distributed control system. According to one example, communication processor node 50 (e.g., of FIG. 3) may comprise the library controller while the other processor nodes (if present) may assist the library controller and/or may provide backup or redundant functionality. In another example, communication processor node 50 and work processor node 52 may work cooperatively to form the library controller while the other processor nodes (if present) may assist the library controller and/or may provide backup or redundant functionality. Still further, all of the processor nodes may comprise the library controller. According to various approaches described and/or suggested herein, a library controller may have a single processor or controller, or it may include multiple processors or controllers, or multiple cores in a processor chip.

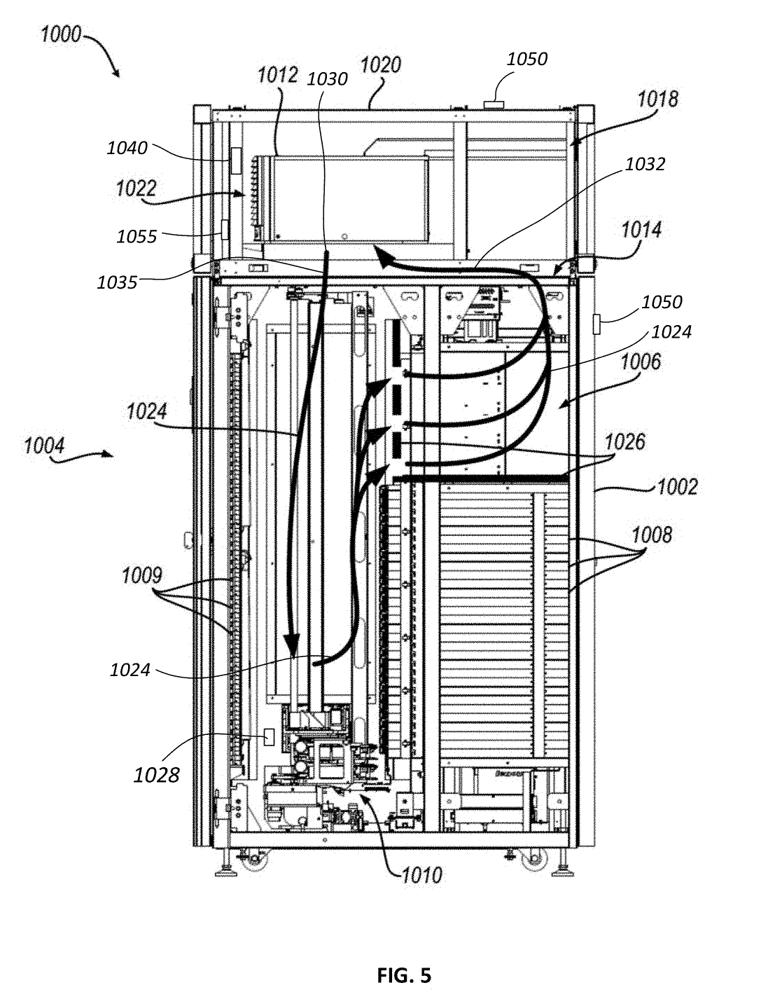

Referring now to FIG. 5, a system 1000 includes a frame 1002 of an automated data storage library 1004. As described above, automated libraries are typically used to store cartridges and drives in large arrays to store large amounts of data. Thus, an interior of frame 1002 is illustrated as a tape library in one embodiment, and is depicted as including one or more tape drives 1006, an area for storing tape cartridges (e.g., multi-cartridge deep slot cells 1008 and single cartridge storage slots 1009), and a robotic accessor 1010, among other components which would be apparent to one skilled in the art upon reading the present description (e.g., see FIG. 2 above).

System 1000 further includes an optional environmental conditioning unit 1012 associated with the frame 1002. The environmental conditioning unit 1012 may be integrated with and coupled to frame 1002. For the purposes of the present disclosure, it is to be understood that an environmental conditioning unit may be any device which conditions the air and/or the surrounding environment and is able to change the environmental conditions. The environmental conditions may include (but are not limited to) temperature, humidity, pressure, etc. In one embodiment, the environmental conditioning unit may be an air-conditioning unit. In other embodiments, the environmental conditioning unit may be a thermo-electric heater, a thermo-electric cooler, an electric heater, a liquid heater, a liquid cooler, a heat pump, an evaporative cooler, an ionizer, a de-ionizer, a humidifier, a dehumidifier, one or more fans, or any combination thereof. An environmental conditioning unit in accordance with one embodiment of the present disclosure may increase or decrease the temperature, humidity, pressure, etc. The environmental conditioning unit 1012 may be coupled to an upper surface 1014 (e.g., the roof) of the frame 1002 as shown in FIGS. 1B and FIG. 5. The environmental conditioning unit 1012 preferably operates without negatively affecting the operating conditions in the frame 1002. Alternatively, an environmental conditioning unit may be functionally associated with the frame 1002 by positioning the environmental conditioning unit elsewhere and using ducts to route the air to the interior of the frame 1002, coupling the environmental conditioning unit to a side of the frame 1002, coupling the environmental conditioning unit to a bottom of the frame 1002 (underneath the frame 1002), etc., depending on the desired approach.

The environmental conditioning unit 1012 is preferably configured such that it may adjust, change and/or regulate the relative conditions (e.g., temperature, humidity, contaminant presence via filtering, etc.) inside the frame 1002. Thus, according to different approaches, the environmental conditioning unit may be able to reduce the temperature of the interior of the frame 1002 and/or reduce the relative humidity of the interior of the frame 1002, depending on the type of environmental conditioning unit 1012 employed. The environmental conditioning unit 1012 is preferably configured to turn on and off as desired to maintain a selected temperature and/or humidity in the interior of the frame 1002. Alternatively, the environmental conditioning unit may have a fan and the fan can be left always on to keep air circulating within the interior of the frame. In one embodiment, the environmental conditioning unit may be an air conditioning unit and the fan may be continuously on and the condenser may turn on and off to maintain a selected temperature and/or humidity in the interior of the frame 1002.

As would be appreciated by one skilled in the art, the environmental conditioning unit 1012 may be an air conditioning unit and may be able to adjust the relative temperature and/or humidity of the interior of the frame 1002 in a conventional manner. Cold air may flow into the interior of the frame 1002 via an inlet air duct 1030 which may connect the environmental conditioning unit 1012 to the interior of the frame 1002, and form an inlet 1035 in the upper surface 1014 of the frame 1002. Specifically, an inlet air duct 1030 may direct the air cooled by the environmental conditioning unit 1012 into the interior of the frame 1002, e.g., where the majority of the data storage media may be stored. As a result, air flow is created from the environmental conditioning unit 1012 to the interior of the frame 1002, as indicated by arrows 1024. This air flow may be induced by a fan included in the air conditioning unit 1012 and/or by using the fans in the one or more tape drives 1006 in the frame 1002. Although the air flow is preferably directed from the environmental conditioning unit 1012 to the interior of the frame 1002, and from the interior of the frame 1002 back to the environmental conditioning unit 1012, the particular path that the air flow is shown as extending along in the present embodiment by arrows 1024 is in no way intended to limit the disclosure or the invention.

With continued reference to FIG. 5, system 1000 may include an enclosure 1020 for the environmental conditioning unit 1012. An additional fan 1040 may be included in the enclosure 1020 for passing ambient air over external components of the environmental conditioning unit 1012 to further promote heating, cooling and/or conditioning of the air. Moreover, the enclosure 1020 may include an opening, a baffle or baffles, etc. to direct ambient air exterior to the library 1004 toward an inlet 1022 of the environmental conditioning unit 1012.

In one embodiment, any vents, voids, seams, etc. in the frame 1002 of the library 1004, other than inlet 1035 and an outlet 1032 in an upper surface 1014 of the frame 1002, are preferably sealed such that air from outside the frame 1002 is restricted from entering the interior thereof. The frame 1002 may be sealed using any processes which would be apparent to one skilled in the art upon reading the present description, e.g., including but not limited to inserting foam, implementing insulating seals, etc. New frames may be built without any vents, voids, seams, etc. The housing and panels enclosing the frame 1002 may also be insulated to prevent or inhibit unconditioned air from entering the frame 1002.

The frame 1002 may also include one or more environmental sensors 1050 exterior to the library 1004 and may also include one or more sensors 1055 exterior to the library 1004 but inside the enclosure 1020 for the environmental conditioning unit 1012. In one embodiment the sensors 1055 may be located in front of inlet 1022 of the environmental conditioning unit 1012. The environmental sensors 1050, 1055 may be any sensor appropriate for determining the environmental conditions at the sensor location, such as one or more temperature sensors, one or more humidity sensors, one or more pressure sensors, etc. The one or more environmental sensors 1050, 1055 may be in communication with a library controller, such as library controller 400 shown and described with respect to FIG. 4. The one or more signals provided by the environmental sensors 1050, 1055 may be utilized to control the output and operation of the environmental conditioning unit 1012. Although the embodiment illustrated in FIG. 5 includes a single frame 1002 and a single environmental conditioning unit 1012, other embodiments may include additional frames and/or environmental conditioning units.

System 1000 illustrated in FIG. 5 may further comprise one or more environmental sensors 1028 disposed within the interior of the library 1002. The environmental sensor(s) may be any appropriate sensor for determining the environmental conditions within the frame 1002, such as, for example, one or more temperature sensors, one or more humidity sensors, one or more pressure sensors, etc. The one or more environmental sensors 1028 may be in communication with a library controller, such as controller 400 shown and described with respect to FIG. 4. As such, the signal provided by the one or more environmental sensors 1028 may be utilized to control the output and operation of the environmental conditioning unit 1012.

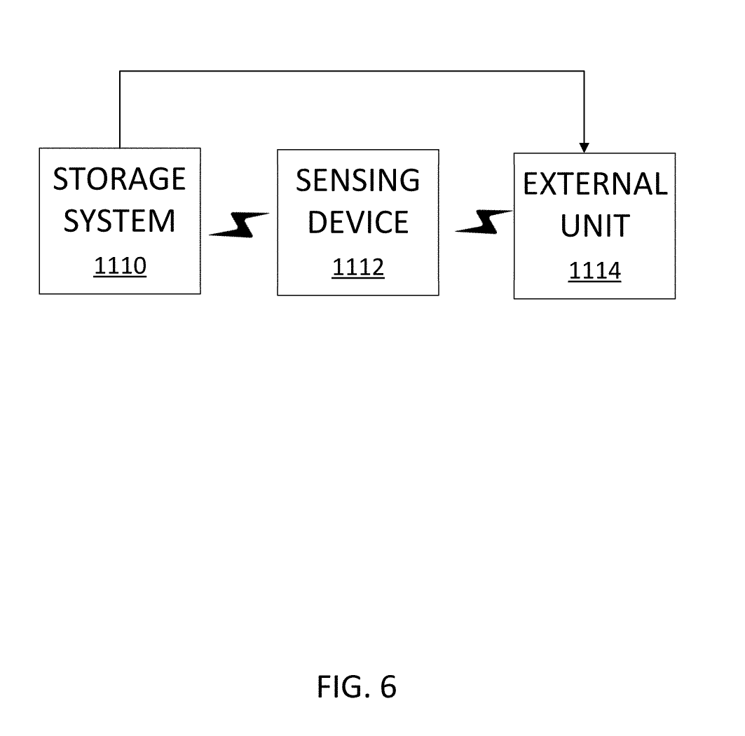

To communicate with, monitor or control any environmental conditioning unit or other external unit(s), various embodiments are further illustrated. In one embodiment, as shown in FIG. 6, a data storage system 1110, such as, for example, a tape library, may be in communication with any external unit 1114 via a sensing device 1112. The sensing device 1112 will act as a bridge between the data storage system and any external unit (unintelligent or conventional devices) so that the data storage system can monitor the status of the external unit. For example, a tape library, such as, for example, the TS4500 library, may have an external unit associated with the data storage library, for example, for maintaining the environmental conditions of the data storage library. The sensing device 1112 may be in communication with both the data storage library and the external unit such that the data storage library may monitor the operational status or conditions of the external unit, which may permit the data storage library to be able to monitor the environmental conditions of the data storage library and/or control other functions of the data storage library.

In an embodiment, the external unit associated with the data storage library may be an environmental conditioning unit such as, for example, an air conditioning unit or other heating / cooling device, a thermo-electric heater, a thermo-electric cooler, a liquid heater, a liquid cooler, a heat pump, an evaporative cooler, an ionizer, a de-ionizer, a humidifier, a dehumidifier, one or more fans, or any combination thereof. The external unit may be other devices, including non-environmental conditioning units, that may be associated with the data storage library, e.g., lighting. The external unit in embodiments may have an analog current draw. The operational status or conditions of the external unit may include, for example, whether the external unit is on or off, or the extent to which the external unit is operational. For example, by sensing whether or not there is current draw to or by the external unit, the data storage library may be able to determine whether the external unit is operational. In other embodiments, the amount of current draw may provide more information on the status and operational condition of the external device. For example, in the situation where the external device is an air-conditioning unit, a certain amount of current draw may indicate that the fan of the air-conditioning unit is operational, whereas a higher current draw may indicate that the compressor is operational, and a yet higher current draw might indicate that both the fan and the compressor is operational, or that the compressor is operational at a higher mode of operation.

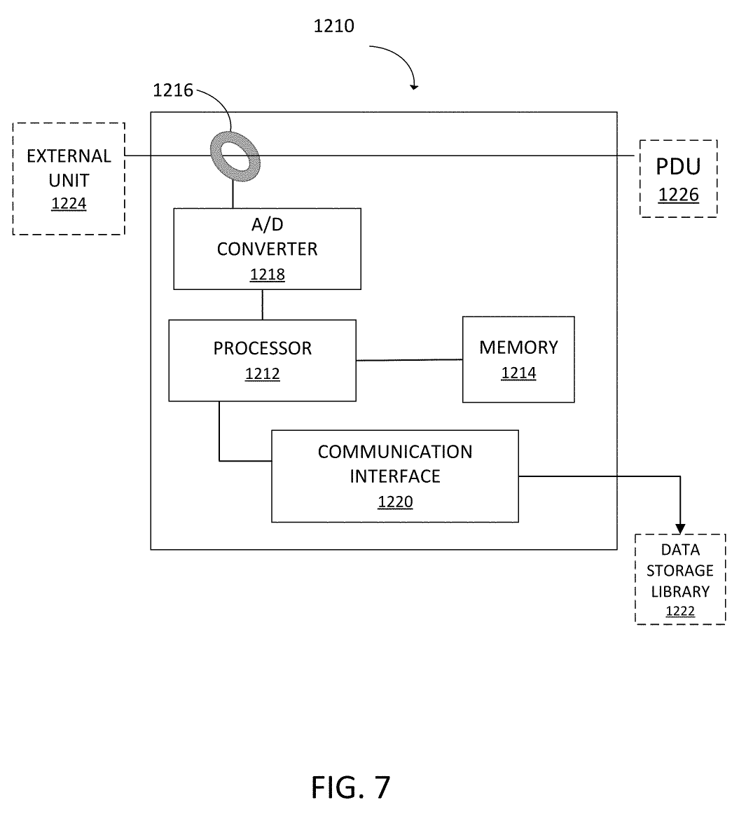

FIG. 7 shows a diagram of a sensing device 1210. In one embodiment, the sensing device 1210 includes a processor 1212, which can be any suitable processor such as, for example, an 8-bit or 16-bit processing unit. Other processors are contemplated. The sensing device may also include an electromagnetic (EM) sensing coil 1216 that can be associated with, such as placed around or in proximity of, and/or couplable to a power line going to the external unit 1224. A magnetic current sensor, for example, a toroidal inductor, may be positioned to sense, monitor and/or measure current draw by the external unit. One example of a toroidal inductor may be a Rogowski coil. Other electromagnetic and/or magnetic sensing devices are contemplated. The power line to the external unit 1224 can be from a power distribution unit (1226) or any power source such as an electrical wall outlet.

In an embodiment, the EM sensing coil 1216 can be configured to receive a signal that is indicative of the operational status or condition of the external unit, such as, for example, the amount of current drawn to or by an environmental conditioning unit, for example, an air conditioning unit. In the simplest form, the signal can be binary, indicating that the external device is on or off when there is current or no current draw to the external unit. The sensing device may also receive a signal that is indicative of a value, such as the amount of current drawn to an air conditioning unit, which the controller of the data storage system can use to determine not only whether the device is on, but based upon the amount of current draw whether it is operating at higher or lower levels of activity.

In an embodiment, the EM sensing coil can be inductively couplable to a power line to the external unit and configured to sense the electromagnetic field that is created by current in a wire. The inductor can sense the electromagnetic field in the wire. The strength of the field is proportional to the amount of current running through the wire such that by sensing and measuring the strength of the electro-magnetic field the coil can sense the amount of current draw. Other methods of sensing and measuring the current are contemplated by the disclosure. When the EM sensing coil is configured to measure the amount of current draw to the external unit, such as, for example, an air conditioning unit, a large current draw from the air conditioning unit may indicate that the compressor is operational, whereas a small current draw may indicate that only the fan is operational.

Alternatively, and/or additionally, the sensing device can also be electrically connected via a first communication interface (not shown) to a power regulator of an environmental conditioning unit associated with the data storage library, such as, for example, an air conditioning unit, and the sensing device can receive a signal that is indicative of the operating current drawn to or by the environmental conditioning unit.

The EM sensing coil 1216 may be configured to receive the signal from the environmental conditioning unit in either analog or digital. If the signal received from the EM sensing coil (or other signal indicative of the operational status or conditions of the environmental conditioning unit) is analog, the sensing device 1210 may optionally have an analog-to-digital (A/D) converter 1218, which converts the analog signal to digital signal. The digital signal may be represented by one or more bytes of data to indicate the value of the signal received from the external unit.

The sensing device 1212 may also include a second communication interface 1220 and a memory 1214 which contains programming instructions to cause the processor to convert the digital signal to a data command. The sensing device 1212 may also include a second communication interface 1220 to transmit the data command to a controller of the data storage library 1222 via the second communication interface 1220. An example of the controller of the data storage library is shown as 50 in FIGS. 3 and 402 in FIG. 4. The second communication interface 1220 is in communication with the processor 1212 and is also couplable to a communication interface of the data storage library so that the processor can transmit the data command to the controller of the data storage library 1222.

The second communication interface 1220 can be a RS-422 interface that connects to the data storage library. The second communication interface 1220 may also be other wired or wireless communication interfaces, such as USB, serial, parallel, Ethernet, or Wi-Fi, Bluetooth or near-field communication (NFC) interface or other known or later developed communication interface.

In one embodiment, the data command can be one or more data packets in accordance with any communication protocols. In a preferred embodiment, the data storage system may communicate in SCSI (Small Computer System Interface) standard, and the data command converted from the digital signal can be a SCSI command. Particularly, the data storage system or an application of the data storage system may communicate with the sensing device over a SCSI service, with a logical unit that declares itself to be an automation/drive interface (ADI). In other words, a SCSI transport protocol can be encapsulated in an ADI standard, or an ADI command standard (ADC).

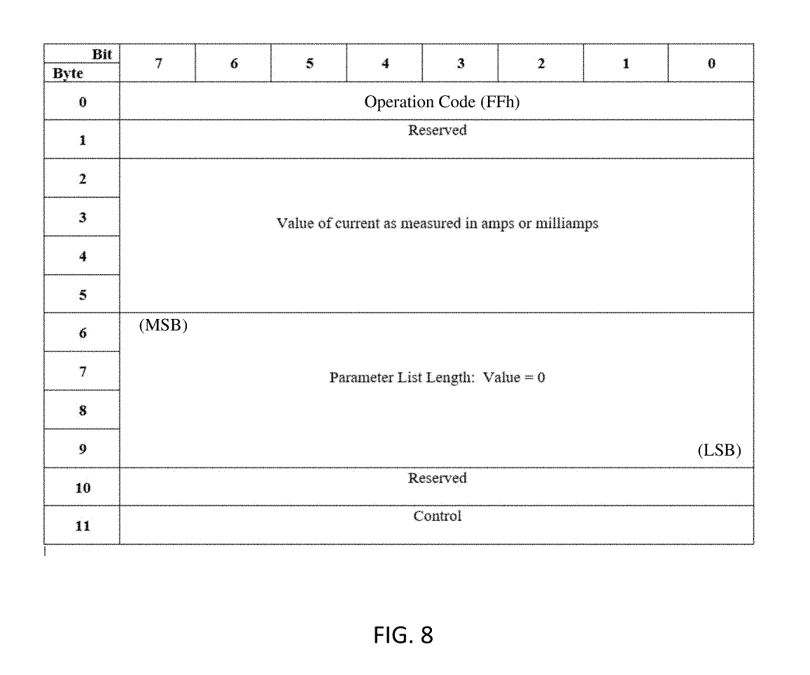

In FIG. 8, a vendor-specific SCSI command according to the ADC standard is shown. The SCSI command can be 12-byte long in compliant with Generic 12-byte Command Description Block (CDB) format as specified in Section 4.2.2.3.1 of the SCSI Primary Commands—5 (SPC-5), Revision 12, Sep. 24, 2016. The vendor-specific SCSI command may contain an operation code (e.g. FFh) that is vendor-specific code in the first byte, followed by a data field that contains a value of the digital signal. For example, the digital signal is indicative of the operating current drawn by the external unit in amps or milliamps, and it is four bytes from byte 2 to 5. One advantage of including the current value in the SCSI command is that the system can monitor/detect the operation status of the external unit without disrupting operations of the monitored device, and without requiring any changes to the monitored device.

The data storage system may be in communication with multiple external units through one or more sensing devices, and each sensing device may be in communication with multiple external units. Accordingly, optionally, the SCSI command may also include a data field to represent a device identification associated with the external unit with which it is communicating, such as a four-byte data field from byte 6 to 9 in the SCSI command. This makes it possible for the SCSI command to stay within the 12 byte ‘vendor specified’ command format as described in the SPC-5 standard document mentioned above. The illustrated data field for device ID is only an example, and other variations may be possible. For example, the device ID field can be any length from 1 byte to 6 bytes, as long as it is contained within the 12 byte CDB total size.

The illustrated embodiments of the sensing device can be used by the data storage library system or an associated application of the data storage library system to monitor the operational status or conditions of the external unit, such as, for example, the air conditioning unit associated with a data storage library.

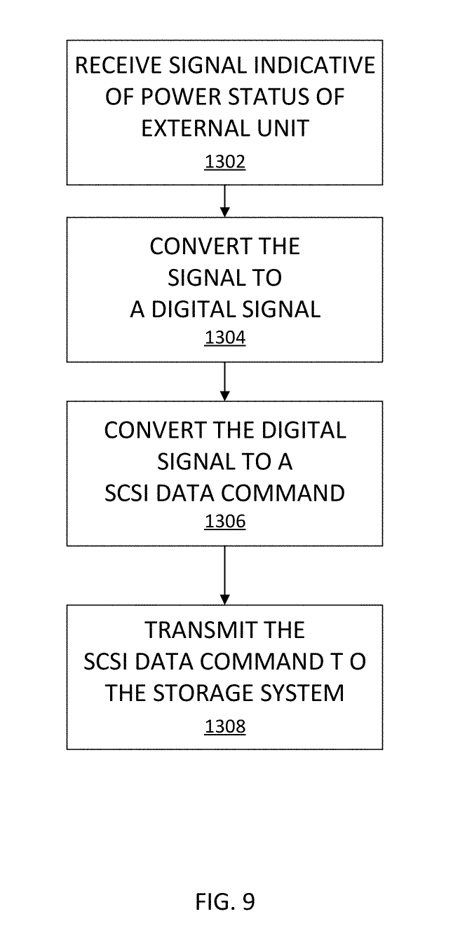

FIG. 9 shows a diagram of a process of monitoring the external unit of a data storage library system according to one embodiment. In one embodiment, the process may monitor power status and/or operating conditions of the external unit. For example, the processor of the sensing device may receive a signal from an external unit 1302 via a communication interface of the sensing device, where the signal is indicative of the power status and/or current draw of the external unit. In one embodiment, the current draw by the external unit is analog. The external unit, for example, may be an environmental conditioning unit such as, for example, an air conditioning unit and the sensing device may receive an analog signal indicative of the operating current drawn from the air conditioning unit. Further, the processor of the sensing device may obtain a digital signal of the analog current signal through an A/D converter 1304. That is the analog current signal may be converted to a digital signal via the A/D converter. The processor of the sensing device may convert the digital signal to a SCSI data command 1306 and transmit the SCSI command to a controller of the data storage system 1308.

While the description has described and illustrated the external unit as an environmental conditioning unit and has used an air-conditioning unit as an example of an external device, it should be appreciated and recognized that the disclosure has application to other environmental conditioning devices, such as electric heaters, thermo-electric heaters, thermo-electric coolers, heat pumps, evaporative coolers, humidifiers, dehumidifiers, ionizers, deionizers, one or more fans and other environmental conditioning units, and additionally, or alternatively, the disclosure has application to external units that do not condition the environmental conditions of the data storage library but have other uses and applications.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages or assembly codes. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGS. 1-9 illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic, such as an electronic circuit, for example, an electronic circuit on a printed circuit board (PCB), integrated with and/or executable by the processor, the logic being configured to perform one or more of the process steps recited herein. In one embodiment, by integrated with, what is meant is that the processor has logic embedded therewith as hardware logic, such as an application specific integrated circuit (ASIC), a field programmable gate array (FPGA), etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

The illustrated embodiments in FIGS. 1-9 are advantageous to existing technologies in that they allow any data storage library system that supports SPC/ADC and ADI standards to be able to monitor any external unit that is not readily compatible with the data storage system by bridging the data storage system and the external unit via a sensing device. The illustrated embodiments provide a well defined communication channel to the library, and will not require substantial changes to the library itself. The implementation will require only additional logic (e.g. software or firmware upgrade) within the library processor to recognize the vendor specific commands, and to display the information to the user appropriately.

The sensing device can be made in a small footprint and inexpensively. For example, a small component interface can be built based on various embodiments disclosed above to connect to the power regulation of an external unit, e.g., an air conditioning unit installed on a tape library, such as the TS4500 tape library. The input to the first communication interface of the sensing device can be an electrical connection of low voltage, and the output of the sensing device can be an Ethernet based connection transmitting a standard ADI interface that reports operational status of the external unit. The advantage is that the sensing device can receive signals from the external device, which allows the monitoring and reporting of the position and current status of the external drive.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A sensing device for monitoring operational conditions of an external environmental conditioning unit associated with but external to a data storage system, where the external environmental conditioning unit is for conditioning an interior of the data storage system, the sensing device comprising:
a processor;
an electromagnetic (EM) sensing coil;
a communication interface communicatively couplable to one or more communication interfaces of the data storage system;
a computer-readable medium containing programming instructions that are configured to cause the processor to:
receive, via the EM sensing coil, a signal indicative of operational conditions of the external environmental conditioning unit;
convert the signal indicative of operational conditions of the external environmental conditioning unit to a SCSI data command; and
transmit, via the communication interface, the SCSI data command to a controller of the data storage system.

2. The sensing device of claim 1, wherein the signal indicative of operational conditions of the external environmental conditioning unit represents an operating electrical current drawn by the external environmental conditioning unit of the data storage system.

3. The sensing device of claim 2, wherein the environmental conditioning unit includes at least one of an air conditioning unit, a heater, a cooler, a dehumidifier, and a fan.

4. The sensing device of claim 2 further comprising an analog-to-digital (A/D) converter, wherein:
the signal is analog;
the A/D converter is communicatively coupled to the EM sensing coil and configured to receive the signal from the EM sensing coil and convert the received signal to a digital signal; and
the programming instructions for converting the signal indicative of operational conditions of the external environmental conditioning unit to the SCSI data command comprise programming instructions that are configured to cause the processor to convert the digital signal to the SCSI data command.

5. The sensing device of claim 4, wherein the SCSI data command comprises a first vendor-specific field containing a value of the digital signal in amps or milliamps, wherein the first vendor-specific field is four bytes.

6. The sensing device of claim 5, wherein the SCSI data command comprises a second vendor-specific field containing a device identification of the external unit, wherein the second vendor-specific field is four bytes.

7. The sensing device of claim 6, wherein the SCSI data command is twelve bytes, a first byte of which contains an operation code.

8. The sensing device of claim 7, wherein the data storage system is a tape library having a plurality of magnetic tape storage cartridges.

9. The sensing device of claim 8, wherein programming instructions for transmitting the SCSI data command comprise programming instructions configured to cause the processor to transmit the SCSI data command to the data storage system in Automation/Drive Interface (ADI) standard.

10. A method of monitoring operational conditions of an environmental conditioning unit associated with a data storage system, where the environmental conditioning unit is external to and for conditioning the environmental conditions of an interior of the data storage system, the method comprising:
receiving, by a processor of a sensing device via an electromagnetic (EM) sensing coil that is associable to a power line to the external environmental conditioning unit, a signal indicative of operational conditions of the external environmental conditioning unit;
converting, by the processor of the sensing device, the signal indicative of operational conditions of the external unit to a SCSI data command; and
transmitting, by the processor of the sensing device via a communication interface of the sensing device, the SCSI data command to a controller of the data storage system, wherein the communication interface is communicatively couplable to a communication interface of the data storage system.

11. The method of claim 10, wherein the signal indicative of operational conditions of the external environmental conditioning unit represents an operating electrical current drawn by the external unit of the data storage system.

12. The method of claim 11, wherein the environmental conditioning unit includes at least one of an air conditioning unit, a heater, a cooler, a dehumidifier, and a fan.

13. The method of claim 11, wherein:
the signal is analog;
receiving the signal indicative of operational conditions of the external environmental conditioning unit of the data storage system comprises receiving the signal from the EM sensing coil and converting the received signal to a digital signal using an analog-to-digital (A/D) converter, wherein the A/D is communicatively coupled to the EM sensing coil; and
converting the signal to the SCSI data command comprises converting the digital signal to the SCSI data command.

14. The method of claim 13, wherein the SCSI data command comprises a first vendor-specific field containing a value of the digital signal in amps or milliamps, wherein the first vendor-specific field is four bytes.

15. The method of claim 14, wherein the SCSI data command comprises a second vendor-specific field containing a device identification of the external unit, wherein the second vendor-specific field is four bytes.

16. The method of claim 15, wherein the SCSI data command is twelve bytes, the first byte of which contains an operation code.

17. The method of claim 16, wherein the data storage system is a tape library having a plurality of magnetic tape storage cartridges.

18. The method of claim 17, wherein transmitting the SCSI data command comprises transmitting the SCSI data command to the data storage system in Automation/Drive Interface (ADI) standard.

19. A system for monitoring an air-conditioning unit for conditioning the interior of a data storage library having a plurality of magnetic tapes, the system comprising:
a processor;
an electromagnetic (EM) sensing coil;
a communication interface communicatively couplable to one or more communication interfaces of the data storage library;
a computer-readable medium containing programming instructions that are configured to cause the processor to:
receive, via the EM sensing coil, a signal indicative of the operating electrical current drawn by the air-conditioning unit,
convert the signal to a SCSI data command, and
transmit, via the communication interface, the SCSI data command to a controller of the data storage library.

20. The system of claim 19 further comprising an analog-to-digital (A/D) converter, wherein:
the signal indicative of the operating electrical current drawn by the air conditioning unit is analog;
the A/D converter is communicatively coupled to the EM sensing coil and configured to receive the signal and convert the received signal to a digital signal; and
the programming instructions for converting the signal indicative of the operating electrical current drawn by the air-conditioning unit to the SCSI data command comprise programming instructions that are configured to cause the processor to convert the digital signal to the SCSI data command.
